(19) United States
(12) Patent Application Publication
(10) Pub. No.: US 2024/0127081 A1
(43) Pub. Date: Apr. 18, 2024

(54) ORDER PREDICTION DEVICE, ORDER PREDICTION METHOD, LEARNING DEVICE, LEARNING METHOD, AND RECORDING MEDIUM

(71) Applicant: NEC Corporation, Minato-ku, Tokyo (JP)

(72) Inventors: Shizuka SATO, Tokyo (JP); Shohei MARUYAMA, Tokyo (JP)

(73) Assignee: NEC Corporation, Minato-ku, Tokyo (JP)

(21) Appl. No.: 18/276,385

(22) PCT Filed: Mar. 26, 2021
(86) PCT No.: PCT/JP2021/012935

§ 371 Date: Aug. 8, 2023

(51) Int. Cl. G06N 5/022

(52) U.S. Cl. CPC G06N 5/022

(57) ABSTRACT

In an order prediction device, an acquisition means acquires event data related to an event. A prediction means predicts a degree of interest with respect to each data item included in the event data and an order prediction by using an attention mechanism based on the event data. An output means outputs, as a prediction result, the degree of interest and an order probability.

### TECHNICAL FIELD

The present disclosure relates to techniques for predicting an order using data associated with a customer.

### BACKGROUND ART

In various industries, exhibitions and trade fairs (hereinafter referred to as an “event”) are held to introduce products and technologies of companies to other companies and to conduct business negotiations regarding product sales and introductions of the technologies. The companies on the exhibition side acquire information of companies from the companies which attend their events and information of the products, the technologies, and the like which they are interested in, and use collected information in their sales activities; however, it is difficult to say that the information collected is always effectively linked to orders.

Note that Patent Document 1 discloses a technique for generating a campaign document having a high effect based on a reaction of a customer to a campaign document used in a previous campaign. Moreover, Patent Document 2 discloses a method for predicting future demand for clothing using results of questionnaires on user preferences and the like.

### PRECEDING TECHNICAL REFERENCES

### Patent Document

Patent Document 1: Japanese Laid-open Patent Publication No. 2013-228934
Patent Document 2: Japanese Laid-open Patent Publication No. 2019-128922

### SUMMARY

### Problem to be Solved by the Invention

It is one object of the present disclosure to predict an order with high accuracy using data collected at events such as exhibitions and the like.

### Means for Solving the Problem

According to an example aspect of the present disclosure, there is provided an order prediction device including:
an acquisition means configured to acquire event data related to an event;
a prediction means configured to predict a degree of interest with respect to each data item included in the event data and an order prediction by using an attention mechanism based on the event data; and
an output means configured to output, as a prediction result, the degree of interest and an order probability.

According to another example aspect of the present disclosure, there is provided an order prediction method including:
acquiring event data related to an event;
predicting a degree of interest with respect to each data item included in the event data and an order prediction by using an attention mechanism based on the event data; and
outputting, as a prediction result, the degree of interest and an order probability.

According to a still another example aspect of the present disclosure, there is provided recording medium storing a program, the program causing a computer to perform a process including:
acquiring event data related to an event;
predicting a degree of interest with respect to each data item included in the event data and an order prediction by using an attention mechanism based on the event data; and
outputting, as a prediction result, the degree of interest and an order probability.

According to a further aspect of the present disclosure, there is provided an order prediction device including:
an acquisition means configured to acquire event data related to an event, and an order history;
a learning means configured to train a prediction model which predicts an order using an attention mechanism based on the event data and the order history; and
an output means configured to output the prediction model trained by the learning means.

According to a still further example aspect of the present disclosure, there is provided an order prediction method including:
acquiring event data related to an event, and an order history;
training a prediction model which predicts an order using an attention mechanism based on the event data and the order history; and
outputting the prediction model trained by the learning means.

According to a yet further example aspect of the present disclosure, there is provided a recording medium storing a program, the program causing a computer to perform a process including:
acquiring event data related to an event, and an order history;
training a prediction model which predicts an order using an attention mechanism based on the event data and the order history; and
outputting the prediction model trained by the learning means.

### Effect of the Invention

According to the present disclosure, it becomes possible to predict an order with high accuracy using data collected at events such as exhibitions and the like.

### BRIEF DESCRIPTION OF THE DRAWINGS

FIG. 1 illustrates an order prediction device according to a first example embodiment.

FIG. 2 is a block diagram illustrating a hardware configuration of the order prediction device.

FIG. 3 is a block diagram illustrating a functional configuration at learning of the order prediction device.

FIG. 4 is a flowchart of a learning process of an order prediction model.

FIG. 5 is a block diagram illustrating a functional configuration of the order prediction device at an order prediction.

FIG. 6 is a flowchart of an order prediction process by the order prediction device.

FIG. 7 is a block diagram illustrating a configuration of the order prediction device including a function using a prediction result.

FIG. 8 is a block diagram illustrating a functional configuration of an order prediction device of a second example embodiment.

FIG. 9 is a flowchart of a process by the order prediction device of the second example embodiment.

FIG. 10 is a block diagram illustrating a functional configuration of an order prediction device of a third example embodiment

FIG. 11 is a flowchart of a process by the learning device of the third example embodiment.

### EXAMPLE EMBODIMENTS

In the following, example embodiments will be described with reference to the accompanying drawings.

### First Example Embodiment

[Schematic Configuration]

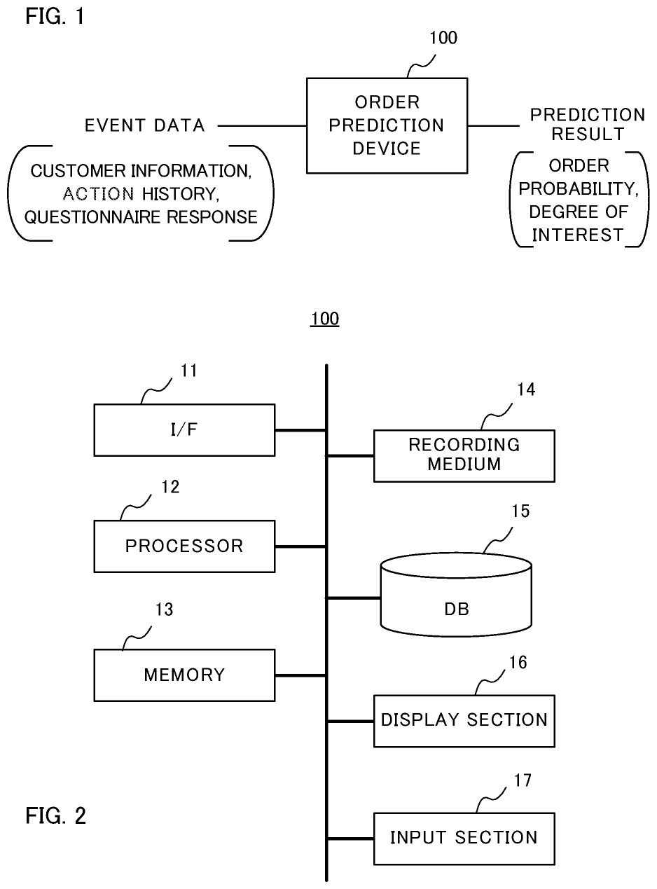

FIG. 1 illustrates an order prediction device according to a first example embodiment. An order prediction device 100 inputs event data, and outputs a prediction result of an order. The event data are data collected at an event such as an exhibition, a trade fair, or the like, and include customer information of each customer who visited the event, an action history of each customer at the event, a response of each customer with respect to a questionnaire conducted at the event, or the like.

In detail, customers include companies and individuals, and in a case of the companies, the customer information includes information such as a job type and a position of a person in charge of the company who visited the event. In addition, the customer information includes a type of business, a scale, a business content, business site information, and the like for each customer. Note that the customer information is not limited to information newly acquired at the event, but also includes information acquired in advance. For instance, for each customer who already has a history of transactions, the customer information includes information already obtained through a previous transaction. For each customer who already has a transaction history, the customer information may include information indicating importance of the customer such as customer ranking.

The action history refers to a history of an action of a customer (visitor) at the event. In a case of a real event held at an event venue such as a convention center, the action history indicates an entry time of the visitor (morning/daytime/evening, time, or the like), an exit time, company booths visited, an order of company booths where the visitor visited, and the like. Noted that in a case of the real event, for instance, code information of a barcode or a QR code (registered trademark) is provided on an admission card which is distributed to the visitor at a time of entry, and it is possible to collect the action history from each customer by scanning code information at an entrance gate and an exit gate or at a booth of each company.

The questionnaire response is an answer of each customer (visitor) to the questionnaire conducted to the visitor in the event venue. The questionnaire response includes, for instance, a reason for visiting the event, a background (received an e-mail invitation, found on a website, or the like), a product or a technology of interest, a degree of interest (planning to introduce, considering introducing, collecting information, or the like), an evaluation and satisfactions concerning the entire event, an exhibition of each company booth, and the like. Note that the questionnaire may be conducted at the event venue, or may be of a type in which visitors answer a website, or other means after leaving the event.

The order prediction device 100 performs prediction of an order for each customer based on the event data, and outputs the prediction result. The prediction result includes an order probability and a degree of interest for each data item included in the event data. The degree of interest indicates a degree in which the order prediction device 100 focuses on each data item in predicting the order, and is calculated for each data item.

In the above example, the order prediction device 100 predicts an order using the customer information, the action history, and the questionnaire response; however, the order prediction device 100 may predict the order using either one of the customer information, the action history, and the questionnaire response. Also, the order prediction device 100 may further predict the order using information other than the action history and the questionnaire response. This point is the same in the following description.

[Hardware Configuration]

FIG. 2 is a block diagram illustrating a hardware configuration of the order prediction device 100. As illustrated, the order prediction device 100 includes an interface (I/F) 11, a processor 12, a memory 13, a recording medium 14, a database (DB) 15, a display section 16, and an input section 17.

The interface 11 inputs and outputs data to and from external devices. In detail, the event data and the data of the order history to be described later are input to the order prediction device 100 through the interface 11.

The processor 12 is a computer such as a CPU (Central Processing Unit) and controls the entire order prediction device 100 by executing programs prepared in advance. The processor 12 may be a GPU (Graphics Processing Unit) or a FPGA (Field-Programmable Gate Array). The processor 12 executes a learning process and an order prediction process, which will be described later.

The memory 13 is formed by a ROM (Read Only Memory) and a RAM (Random Access Memory). The memory 13 is also used as a working memory during operations of various process by the processor 12.

The recording medium 14 is a non-volatile and non-transitory recording medium such as a disk-shaped recording medium, a semiconductor memory, or the like, and is configured to be detachable with respect to the order prediction device 100. The recording medium 14 records various programs executed by the processor 12. When the order prediction device 100 executes various processes, the programs recorded in the recording medium 14 are loaded into the memory 13 and executed by the processor 12. The DB 15 stores event data and order history data as needed.

The display section 16 is, for instance, a liquid crystal display device, and displays information to a user. The prediction result by the order prediction device 100 can be displayed on the display section 16. The input section 17 is an input device such as a keyboard and a mouse and is operated by the user.

[Training Order Prediction Model]

(Configuration at Learning)

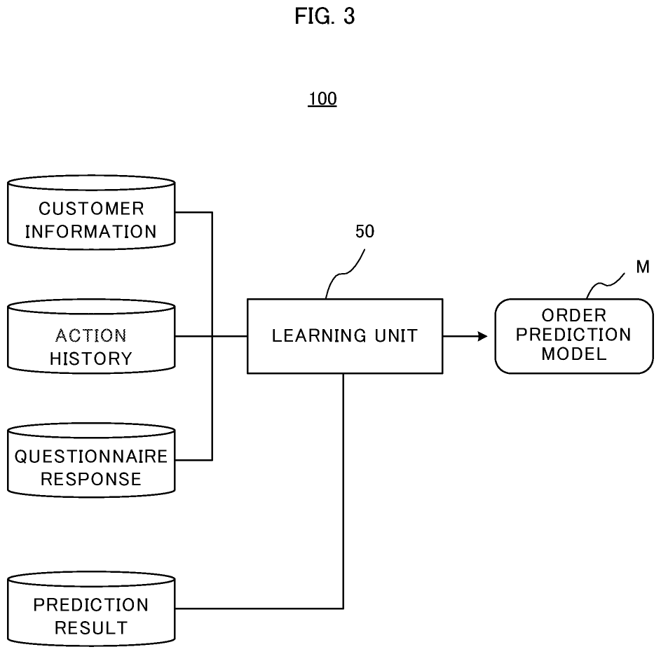

FIG. 3 is a block diagram illustrating a functional configuration of the order prediction device 100 at learning. The order prediction device 100 at the learning includes a learning unit 50. The learning unit 50 performs training of the machine learning model, and generates an order prediction model M.

In detail, training data are input to the learning unit 50. The training data includes the event data and the order history. As the event data, the customer information, the action history, and the questionnaire responses collected in association with previous events are used. In addition, the order history indicates an actual number of orders received for each customer in the previous events. That is, as the training data, the customer information, the behavior information and the questionnaire response which are related to the previous event, and a history of whether or not the customer has ordered a product or technology actually introduced at the event are used. In the training of the order prediction model M, the event data correspond to input data for the training, and the order history corresponds to correct answer data for the learning.

The learning unit 50 learns the machine learning model using an attention mechanism (Attention Mechanism), and generates a trained model as the order prediction model M. The attention mechanism is regarded as a technique used in deep learning or the like, and corresponds to a mechanism which determines where to direct attention and focus on the input data. By using the order prediction model M provided with the attention mechanism, it is possible to know which items of input data were focused on to obtain the prediction result. In the present example embodiment, by predicting the order with the order prediction model M provided with the attention mechanism, it is possible to obtain not only the order probability as described above but also the degree of interest for each data item of the event data.

In detail, the learning unit 50 trains the order prediction model M by analyzing a relationship between each data item included in the customer information, the action history, and the questionnaire response which are included in the event data, and the order history of the customer (track record of the order received or not). Thus, in response to an input of the event data, the order prediction model M obtained by the learning determines the degree of interest of each data item included in the event data, that is, how much each data item affects and contributes to the order probability, and calculates the order probability based on degrees of interest for respective data items. The order prediction model M thus obtained is used for an order prediction by the order prediction device 100.

(Learning Process)

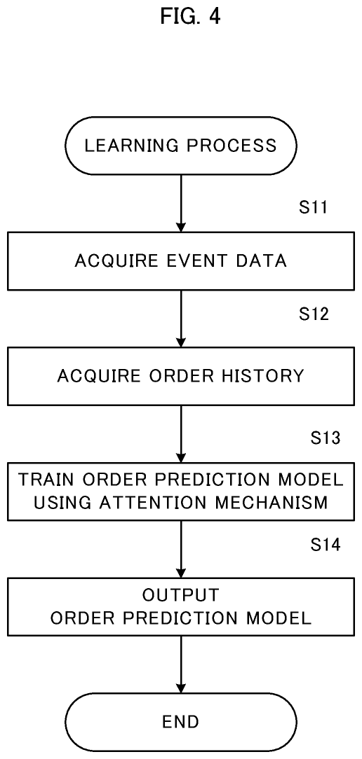

FIG. 4 is a flowchart of the learning process for generating the order prediction model M. This process is realized by the processor 12 depicted in FIG. 2, which executes a program prepared in advance and functions as the learning unit 50 depicted in FIG. 3.

First, the learning unit 50 acquires the event data including the customer information, the action history, and the questionnaire response (step S11). Moreover, the learning unit 50 acquires a previous order history of each customer included in the acquired event data (step S12). Next, the learning unit 50 analyzes the relationship between the event data and the order history using the attention mechanism, and trains the order prediction model M (step S13). After that, the learning unit 50 terminates the learning when a predetermined learning condition is provided, and outputs the trained order prediction model M (step S14). Accordingly, for the input of the event data, it is possible to acquire the order prediction model M for outputting each data item of interest and the order probability.

[Order Prediction]

(Configuration at Order Prediction)

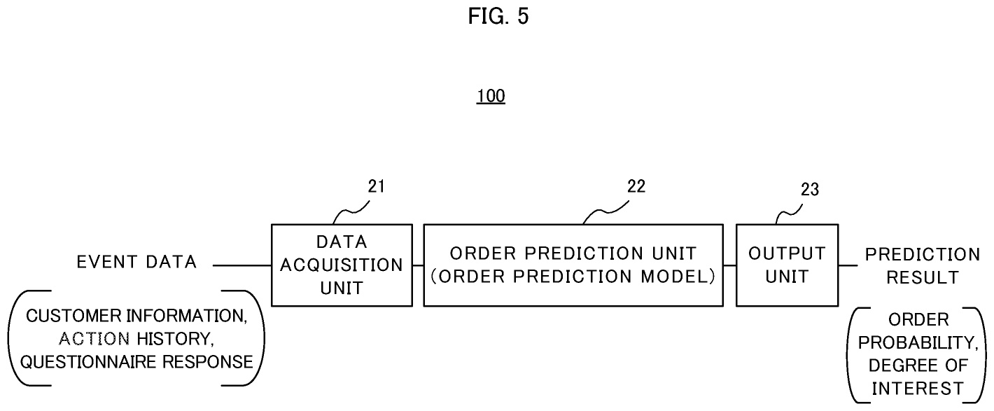

FIG. 5 is a block diagram illustrating a functional configuration of the order prediction device 100 at the order prediction. The order prediction device 100 at the order prediction includes a data acquisition unit 21, an order prediction unit 22, and an output unit 23. The data acquisition unit 21 acquires the event data including the customer information, the action history, and the questionnaire response, and outputs the event data to the order prediction unit 22. The order prediction unit 22 performs prediction from the event data using the order prediction model M generated by the learning process described above. The output unit 23 outputs, as the prediction result, the order probability and the degree of interest for each data item included in the event data. The order probability is output as a value between 0 to 100%, for instance. The order prediction device 100 may output the degree of interest for all data items included in the event data, or may output the degree of interest for only data items of which each degree of interest is higher than a predetermined threshold value.

The order probability obtained as the prediction result may be used to determine a sales strategy for each customer thereafter. For instance, it is possible for a sales representative to efficiently conduct sales activities by giving priority to customers with a high probability of the order. As the prediction result, among the data items included in the event data, data items with a high degree of interest are known, and thus by increasing the accuracy of the data amount or data collected for the data items with a high degree of interest, it is possible to improve the accuracy of the order prediction by the order prediction device 100.

(Order Prediction Process)

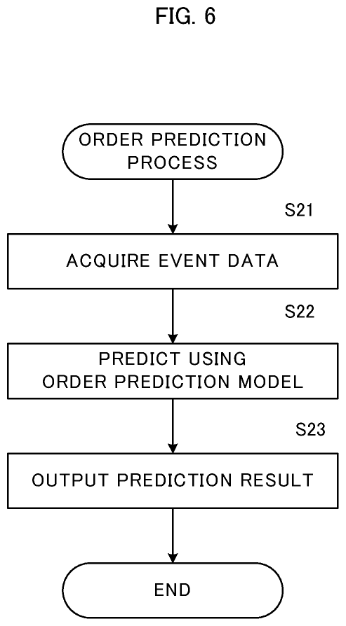

FIG. 6 is a flowchart of the order prediction process performed by the order prediction device 100. This order prediction process is realized by the processor 12 depicted in FIG. 2 which executes a program prepared in advance and functions as each element depicted in FIG. 5.

First, the data acquisition unit 21 acquires the event data including the customer information, the action history, and the questionnaire response for each customer who has visited the event (step S21). Next, the order prediction unit 22 performs prediction based on the event data using the order prediction model M obtained by the learning (step S22). Next, the output unit 23 outputs the order probability for each customer and the degree of interest for each data item as the prediction result (step S23). Note that the output unit 23 may display the prediction result on the display section 16, and may output the prediction result to an external terminal device. After that, the order prediction process is terminated.

[Modification]

In the above-described example embodiment, the event is assumed to be a real event held at a convention center or the like; however, instead, the event may be an event performed at a web-based site (hereinafter, referred to as a “Web event”). For instance, the Web event corresponds to an exhibition on-line or a trade fair on-line (also called an on-line exhibition or an on-line trade fair). Even in a case of the Web event, the learning process and the order prediction process described above are the same as for the real event, but there are different aspects of the event data collection method.

Specifically, for a new customer with no previous transaction history in the past, the customer information includes information input within an event site by a person visiting the event site (hereinafter, referred to as a “visitor”). The event history is also acquired as a log of operations performed by the visitor within the event site. For instance, the action history includes a visit history (visited or not, date and time, an order of visits, duration of stay, and the like) of a company page where the visitor visited in the event site, information of the materials downloaded by the visitor in the company page, information concerning a video content viewed by the visitor in the company page, and the like. In addition, as questionnaire responses, answers entered by visitors are collected for questionnaires presented on the Web. Note that the questionnaire may be related to the entire event site, or may be prepared for each company page.

[Use of Prediction Results]

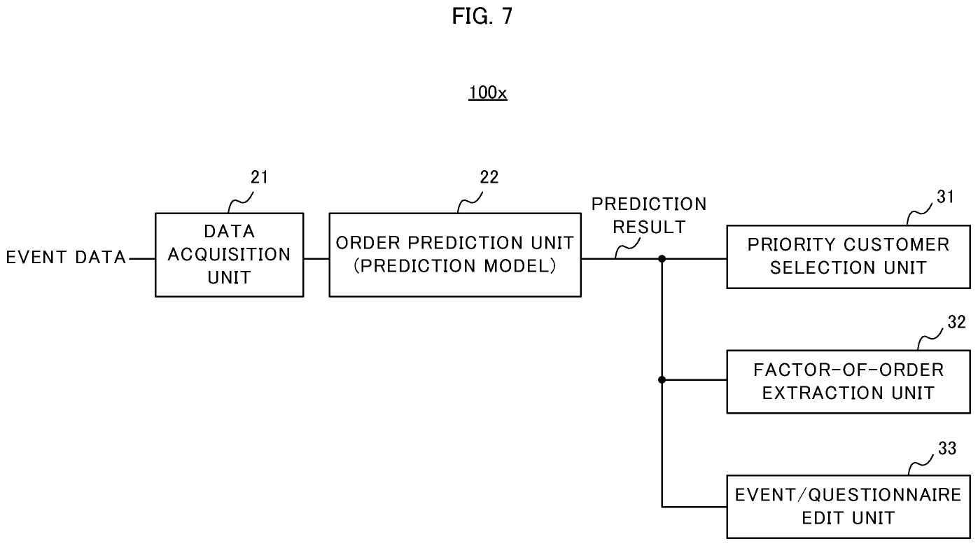

Next, an example of using prediction results by the order prediction device 100 will be described. FIG. 7 is a block diagram illustrating a configuration of an order prediction device 100x in which a function of using prediction results is added. As illustrated in FIG. 7, the order prediction device 100x includes a priority customer selection unit 31, an order factor extraction unit 32, and an event/questionnaire edit unit 33 as well as to the data acquisition unit 21 and the order prediction unit 22. Each prediction result generated by the order prediction unit 22, that is, the order probability and the degree of interest for each data item are input to the priority customer selection unit 31, the order factor extraction unit 32, and the event/questionnaire edit unit 33.

The priority customer selection unit 31 selects each priority customer, that is, each important customer, based on the order probability included in each prediction result. For instance, the priority customer selection unit 31 compares the order probability with a predetermined reference probability, and selects, as the priority customer, each customer having a higher order probability than a reference probability. It is possible for a sales representative to strengthen sales activities for each priority customer.

The order factor extraction unit 32 extracts an order factor based on the degree of interest for each data item included in the prediction result. The order factor is a factor leading to an order or a factor contributing to the order. For instance, the order factor extraction unit 32 compares the degree of interest for each data item included in the prediction result with a predetermined reference degree of interest, and extracts the data item having the degree of interest higher than the reference degree of interest as the order factor.

In addition, the order factor extraction unit 32 may extract a combination of a plurality of data items each having a high degree of interest as the order factor in a case of acquiring an order probability higher than the reference probability as the prediction result. For instance, in a case where the prediction result is obtained in which “the order probability is higher when a person in a position B in an industry type A performs an action C”, the order factor extraction unit 32 may extract a combination of the “industry type A”, the “position B”, and the “action C” as the order factors. Accordingly, it is possible for sales representatives and others to understand matters which are effective in leading to orders and apply the matters in their sales activities.

The event/questionnaire edit unit 33 improves planning of next and subsequent events, items of the questionnaire to be conducted at the event, and the like based on the degree of interest for each data item included in the prediction result. In detail, the event/questionnaire edit unit 33 may extract the data item having the degree of interest higher than the reference degree of interest, and output the planning and opening conditions of the next event. For instance, in a case where the prediction result indicating “a customer of an industry type D has a high order probability for a technology in a technology field E” is obtained, the event/questionnaire editing section 33 may output a condition of “the event of the technology field E for the industry type D” for the next event.

The event/questionnaire edit unit 33 may generate proposed changes to the questionnaire based on the degree of interest for each data item included in the prediction result. In detail, in a case where it is assumed that the questionnaire is generated and edited by selecting from among a plurality of questionnaire items prepared in advance, the event/questionnaire edit unit 33 may edit the questionnaire so as to increase questionnaire items related to that questionnaire item when the degree of interest of the questionnaire response to a certain questionnaire item is high. For instance, the event/questionnaire edit unit 33 may refer to the degree of interest for each questionnaire response included in the prediction result, and adopt the questionnaire items in an order of higher degree of interest.

As described above, by changes to improve a content of the event and contents of the questionnaire, it is possible to plan events with more visitors or generate the questionnaire with a higher response rate. Therefore, it is possible to contribute to successful sales activities and an increase of sales.

### Second Example Embodiment

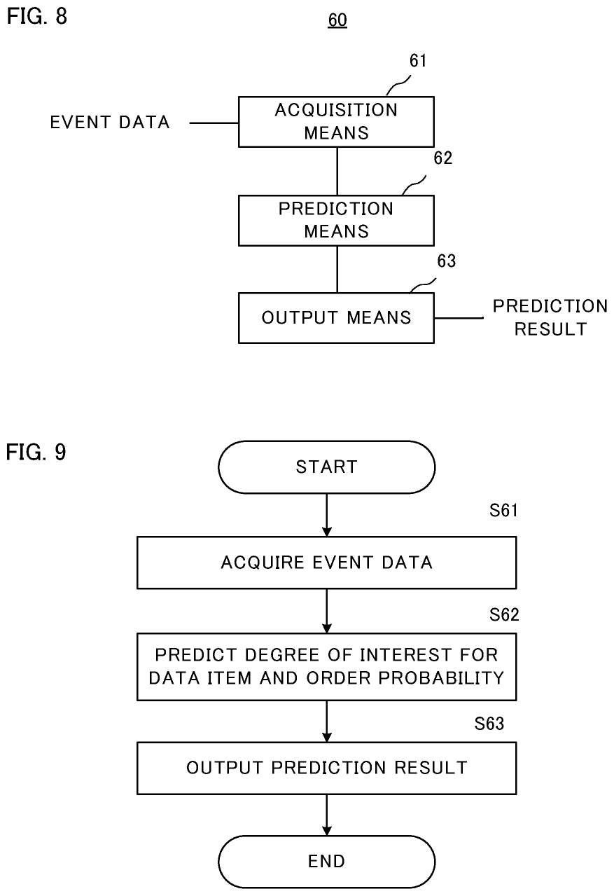

FIG. 8 is a block diagram illustrating a functional configuration of an order prediction device according to a second example embodiment. An order prediction device 60 includes an acquisition means 61, a prediction means 62, and an output means 63.

FIG. 9 is a flowchart of a process performed by the order prediction device 60 according to the second example embodiment. The acquisition means 61 acquires the event data related to the event (step S61). Based on the event data, the prediction means 62 predicts the degree of interest for each data item included in the event data and each order probability by using the attention mechanism (step S62). The output means 63 outputs the predicted degrees of interest and the predicted order probabilities as the predicted result (step S63).

According to the order prediction device 60 of the second example embodiment, using data collected at the event, it is possible to predict the order with high accuracy.

### Third Example Embodiment

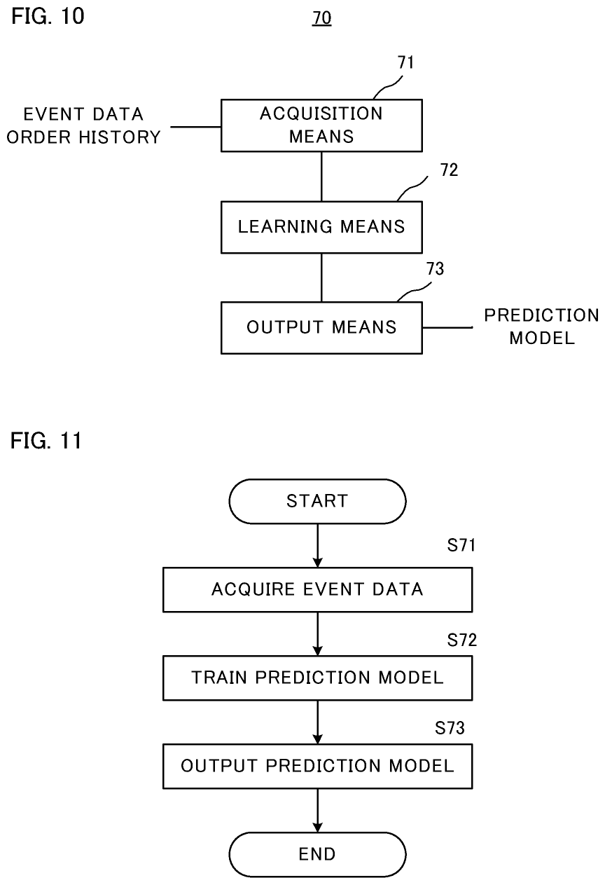

FIG. 10 is a block diagram illustrating a functional configuration of a learning device according to a third example embodiment. A learning device 70 includes an acquisition means 71, a learning means 72, and an output means 73.

FIG. 11 is a flowchart of a process performed by the learning device 70 according to the third example embodiment. The acquisition means 71 acquires the event data related to the event and the order history (step S71). Based on the event data and the order history, the learning means 72 learns the prediction model for predicting the order using the attention mechanism (step S72). The output means 73 outputs a trained prediction model by the learning unit (step S73).

According to the learning device of the third example embodiment, it is possible to generate a model for predicting an order with high accuracy from data related to the event.

A part or all of the example embodiments described above may also be described as the following supplementary notes, but not limited thereto.

(Supplementary Note 1)

An order prediction device comprising:
an acquisition means configured to acquire event data related to an event;
a prediction means configured to predict a degree of interest with respect to each data item included in the event data and an order prediction by using an attention mechanism based on the event data; and
an output means configured to output, as a prediction result, the degree of interest and an order probability.

(Supplementary Note 2)

The order prediction device according to supplementary note 1, wherein
the event data include customer information of each customer who attended the event, and
the order probability is a probability of each order of the customer.

(Supplementary Note 3)

The order prediction device according to supplementary note 2, wherein the event data include at least one of an answer of the customer with respect to a questionnaire and an action history of the customer at the event.

(Supplementary Note 4)

The order prediction device according to supplementary note 3, further comprising a priority customer selection means configured to output information of each customer having the order probability higher than a predetermined reference probability as a priority customer.

(Supplementary Note 5)

The order prediction device according to any one of supplementary notes 1 to 4, further comprising an order factor extraction means configured to output each data item having the degree of interest higher than a predetermined reference degree of interest, as an order factor.

(Supplementary Note 6)

The order prediction device according to any one of supplementary notes 1 to 5, further comprising a questionnaire edit means configured to edit questionnaire items included in the questionnaire based on each data item having the degree of interest higher than a predetermined reference degree of interest.

(Supplementary Note 7)

An order prediction method comprising:
acquiring event data related to an event;
predicting a degree of interest with respect to each data item included in the event data and an order prediction by using an attention mechanism based on the event data; and
outputting, as a prediction result, the degree of interest and an order probability.

(Supplementary Note 8)

A recording medium storing a program, the program causing a computer to perform a process comprising:
acquiring event data related to an event;
predicting a degree of interest with respect to each data item included in the event data and an order prediction by using an attention mechanism based on the event data; and
outputting, as a prediction result, the degree of interest and an order probability.

(Supplementary Note 9)

An order prediction device comprising:
an acquisition means configured to acquire event data related to an event, and an order history;
a learning means configured to train a prediction model which predicts an order using an attention mechanism based on the event data and the order history; and
an output means configured to output the prediction model trained by the learning means.

(Supplementary Note 10)

The order prediction device according to supplementary note 9, wherein the event data include customer information of a customer who attended the event, an answer of the customer with respect to a questionnaire, and an action history of the customer at the event.

(Supplementary Note 11)

An order prediction method comprising:
acquiring event data related to an event, and an order history;
training a prediction model which predicts an order using an attention mechanism based on the event data and the order history; and
outputting the prediction model trained by the learning means.

(Supplementary Note 12)

A recording medium storing a program, the program causing a computer to perform a process comprising:
acquiring event data related to an event, and an order history;
training a prediction model which predicts an order using an attention mechanism based on the event data and the order history; and
outputting the prediction model trained by the learning means.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

12 Processor
21 Data acquisition unit
22 Order prediction unit
31 Priority customer selection unit
32 Order factor extraction unit
33 Event/questionnaire edit unit
50 Learning unit

What is claimed is:

1. An order prediction device comprising:
a first memory storing first instructions; and
one or more first processors configured to execute the first instructions to:
acquire event data related to an event;
predict a degree of interest with respect to each data item included in the event data and an order prediction by using an attention mechanism based on the event data; and
output, as a prediction result, the degree of interest and an order probability.

2. The order prediction device according to claim 1, wherein
the event data include customer information of each customer who attended the event, and
the order probability is a probability of each order of the customer.

3. The order prediction device according to claim 2, wherein the event data include at least one of an answer of the customer with respect to a questionnaire and an action history of the customer at the event.

4. The order prediction device according to claim 3, wherein the processor is further configured to output information of each customer having the order probability higher than a predetermined reference probability as a priority customer.

5. The order prediction device according to claim 1, wherein the processor is further configured to output each data item having the degree of interest higher than a predetermined reference degree of interest, as an order factor.

6. The order prediction device according to claim 1, wherein the processor is further configured to edit questionnaire items included in the questionnaire based on each data item having the degree of interest higher than a predetermined reference degree of interest.

7. An order prediction method comprising:
acquiring event data related to an event;
predicting a degree of interest with respect to each data item included in the event data and an order prediction by using an attention mechanism based on the event data; and
outputting, as a prediction result, the degree of interest and an order probability.

8. A non-transitory computer-readable recording medium storing a program, the program causing a computer to perform the order prediction method according to claim 7.

9. An order prediction device comprising:
a second memory storing second instructions; and
one or more second processors configured to execute the second instructions to:
acquire event data related to an event, and an order history;
train a prediction model which predicts an order using an attention mechanism based on the event data and the order history; and
output the prediction model being trained.

10. The order prediction device according to claim 9, wherein the event data include customer information of a customer who attended the event, an answer of the customer with respect to a questionnaire, and an action history of the customer at the event.

11. An order prediction method performed by the order prediction device according to claim 9.

12. A non-transitory computer-readable recording medium storing a program, the program causing a computer to perform as the order prediction device according to claim 9.
